(19) United States
(12) Patent Application Publication
(10) Pub. No.: US 2020/0359575 A1
(43) Pub. Date: Nov. 19, 2020

(54) Guard

(71) Applicant: Malcolm Wilson, Dingley Village (AU)

(72) Inventor: Malcolm Wilson, Dingley Village (AU)

(21) Appl. No.: 16/875,730

(22) Filed: May 15, 2020

(30) Foreign Application Priority Data
May 17, 2019 (AU) 2019100534
May 17, 2019 (AU) 2019901679

(51) Int. Cl. A01G 13/02

(52) U.S. Cl. CPC A01G 13/0243; A01G 13/0281

(57) ABSTRACT

A guard includes a wall arrangement defining, or being configurable to define, an enclosure. The wall arrangement having, or is configurable to have, an aperture for receiving an elongate support to secure the enclosure to a ground surface. The aperture is defined at least by two side edges that provide the aperture with an aperture height and that are spaced apart from each other to provide the aperture with an aperture width.

### RELATED APPLICATIONS

The present application claims priority to Australia Patent Application No. 2019901679, filed on May 17, 2019, and Australia Innovation Patent No. 2019100534, filed on May 17, 2019, which are incorporated by reference in their entirety herein.

### FIELD OF THE INVENTION

The invention relates to a guard. Embodiments of the present invention relate to a plant guard or a tree guard.

### BACKGROUND

An existing guard for protecting a plant is shown in FIG. 6. The back panel of this existing guard has two horizontal slots or cuts, which are near the top and the bottom of the panel. To secure the guard to the ground, a stake is inserted through the guard from inside the guard through the top slot to outside the guard, then back inside the guard through the bottom slot, and driven into the ground.

This guard would not be able to stay securely in place relative to the stake. The guard could easily twist or rotate, especially in windy conditions, which would kill the plant or expose the plant to predation.

Also, where the guard is formed from folding a flat sheet, it can be difficult to properly align the slots and hold the guard in place while passing the stake through the slots.

Embodiments of the present invention seek to provide a guard that does not substantially swivel or substantially rotate when it is secured by a stake to a ground surface. Embodiments of the present invention also seek to provide a guard that is easy to assemble.

### SUMMARY OF THE INVENTION

According to an aspect of the present invention, there is provided a guard including a wall arrangement defining, or being configurable to define, an enclosure, the wall arrangement having, or being configurable to have, an aperture for receiving an elongate support to secure the enclosure to a ground surface, the aperture being defined at least by two side edges that provide the aperture with an aperture height (or aperture length) and that are spaced apart from each other to provide the aperture with an aperture width.

The elongate support is preferably a stake. For example, the elongate support is a wooden stake. The elongate support preferably has a substantially square cross-sectional area. The elongate support has, along a substantial length of the elongate support, a cross-sectional area with a width of between about 10 mm and 30 mm and a depth of between about 10 mm and 30 mm. As an example, the elongate support has a width of about 25 mm and a depth of about 15 mm.

The aperture is preferably at least thumb size. The aperture height (or aperture length) is preferably greater than the aperture width. For example, the aperture height may be greater than 1.2 times the aperture width. Preferably, the aperture height may be greater than about 2 times the aperture width. The aperture width is preferably greater than 1 cm. Preferably, the aperture width is up to about 4 cm.

Preferably, the side edges contact the elongate support, when received by the aperture, along a length of the elongate support. Preferably, passing the elongate support member through the aperture pushes against at least a portion of the side edges. Portions of the side edges preferably embrace, hug, or frictionally contact a length portion of the elongate support when the elongate support is received by the aperture. For example, when the elongate support is inserted through the aperture, it pushes the side edges inwardly or outwardly causing portions of the guide edges to flex to thereby clamp or trap the elongate support therebetween. The side edges preferably have portions that are nonparallel to each other. As an example, portions of the side edges of the aperture are angled away from each other or are angled towards each other. As another example, portions of the side edges of the aperture are curved. The aperture preferably has a first edge from which the two side edges extend, the first edge having a width that is substantially equal to or less than a width of the elongate support. The two side edges preferably extend from the first edge away from each other to provide the aperture with an opening through which the elongate support can pass. The opening may have a width that is greater than the width of the elongate support. The side edges may for example extend from the first edge at an angle of between about 91° and 120°, preferably about 100°.

The wall arrangement is preferably made from a flexible material. As an example, the wall arrangement is made from plastic. As another example, the wall arrangement is made from natural fiber. As a further example, the wall arrangement is made from cardboard. As yet a further example, the wall arrangement is made from a plant fiber. As yet another example, the wall arrangement is made from a recyclable material and/or biodegradable material.

The wall arrangement is preferably a sheet that can be configured to define the enclosure. As an example, the sheet may be rolled to define the enclosure. As another example, the sheet may be folded to define the enclosure. The sheet may have tab portions that are foldable to retain the enclosure configuration. These tab portions may be provided within the sheet or may be provided along edges of the sheet.

The enclosure may be a substantially cylindrical enclosure. Alternatively, the enclosure may have a height with a substantially triangular-shaped cross-sectional area. Further alternatively, the enclosure may have a height with a substantially square-shaped cross-sectional area.

The wall arrangement preferably defines a solid barrier into the enclosure.

The wall arrangement may have, or may be configurable to have, two apertures vertically spaced apart from each other. Preferably, the elongate support skewers the wall arrangement through the two apertures to secure the enclosure to the ground surface. Preferably, the elongate support passes through one aperture from a first side of the enclosure, exits that aperture and enters the other aperture from a second side of the enclosure, and exits the other aperture from the first side of the enclosure. Preferably, the first side of the enclosure corresponds to an inside surface of the enclosure and the second side of the enclosure corresponds to an outside surface of the enclosure. Preferably, a portion of the elongate support between the two apertures pushes against the wall arrangement in a first direction, and portions of the elongate support not-between the two apertures push against the wall arrangement in a second direction opposite to the first direction. The wall arrangement may have more than two apertures spaced apart from each other through which the elongate support is passable.

The wall arrangement may be configured to provide the aperture for receiving the elongate support. The wall arrangement preferably has a first region with a tab portion and a second region, the tab portion in the first region being foldable into the second region to substantially retain the configuration of the enclosure. The first region may be provided towards one end of the wall arrangement and the second region may be provided towards an opposite end of the wall arrangement. The aperture may be defined when the tab portion in the first region is folded. The second region of the sheet may have a tab portion that is foldable such that the tab portions in the first and second regions, when aligned, are foldable to provide the aperture for receiving the elongate support. Alternatively, the second region has a hole into which the tab portion in the first region is foldable.

Preferably, the tab portion(s) when folded frictionally contact a surface of the elongate support received by the aperture.

According to another aspect of the present invention, there is provided a guard including a wall arrangement being configurable to define an enclosure, the wall arrangement having a first region with a tab portion and a second region, wherein the tab portion in the first region is foldable towards the second region to substantially retain the configuration of the enclosure such that, folding the tab portion reveals an aperture through which an elongate support is passable to secure the enclosure to a ground surface.

The guard of this aspect may include features of the guard of the aspect previously described.

The first region may be provided towards one end of the sheet and the second region may be provided towards an opposite end of the sheet.

The second region of the wall arrangement may have a tab portion that is foldable such that the tabs portions in the first and second regions, when aligned, are foldable to provide the aperture for receiving the elongate support. Alternatively, the second region may have a hole into which the tab portion of the first region is foldable.

The tab portions are preferably foldable in an upward or downward direction. The tab portions, when folded, preferably provide extra stiffness or rigidity to the wall arrangement, in a vicinity of the aperture, against which the elongate support through the aperture presses. The tab portions, when folded, preferably frictionally contact a surface of the elongate support post through the aperture.

According to another aspect of the present invention, there is provided a guard including a wall arrangement defining, or being configurable to define, an enclosure, the enclosure having an angled end that can be used as a base of the enclosure such that when the angled end is used as the base on a sloping ground surface, the wall arrangement is substantially upright.

The guard of this aspect may include features of the guard of either of the aspects previously described.

Preferably, the enclosure has an opposite end that is substantially flat that can be used as the enclosure base, such that when the opposite end of the enclosure is used as the base on a substantially flat ground surface, the wall arrangement is substantially upright.

The wall arrangement may be provided by a sheet that is configured to define the enclosure. The sheet preferably has an edge that is concave or curved to define the angled end of the base of the enclosure. Preferably, an opposite edge of the sheet is substantially straight to define a flat base for the enclosure.

According to another aspect of the present invention, there is provided a sheet for forming a guard of any one of the aspects previously described above.

The sheet may be a blank.

According to a further aspect of the present invention, there is provided a mat including a sheet having an aperture for receiving a plant, the sheet having a slot extending from an edge of the sheet toward the aperture to define a flap that is foldable to provide a passage into the aperture.

The slot may has a curved portion.

### BRIEF DESCRIPTION OF THE DRAWINGS

The invention will now be described, by way of non-limiting example only, with reference to the accompanying drawings, in which:

FIGS. 1A to 1E show the steps for erecting a guard according to an embodiment of the present invention;

FIG. 2 shows a sheet for a guard according to another embodiment of the present invention;

FIG. 3 shows a sheet for a guard according to another embodiment of the present invention;

FIGS. 4A to 4C show a mat for use with the guard according to embodiments of the present invention;

FIG. 5 shows an guard with a mat according to an embodiment of the present invention; and

FIG. 6 shows a tree guard according to the prior art.

### DETAILED DESCRIPTION

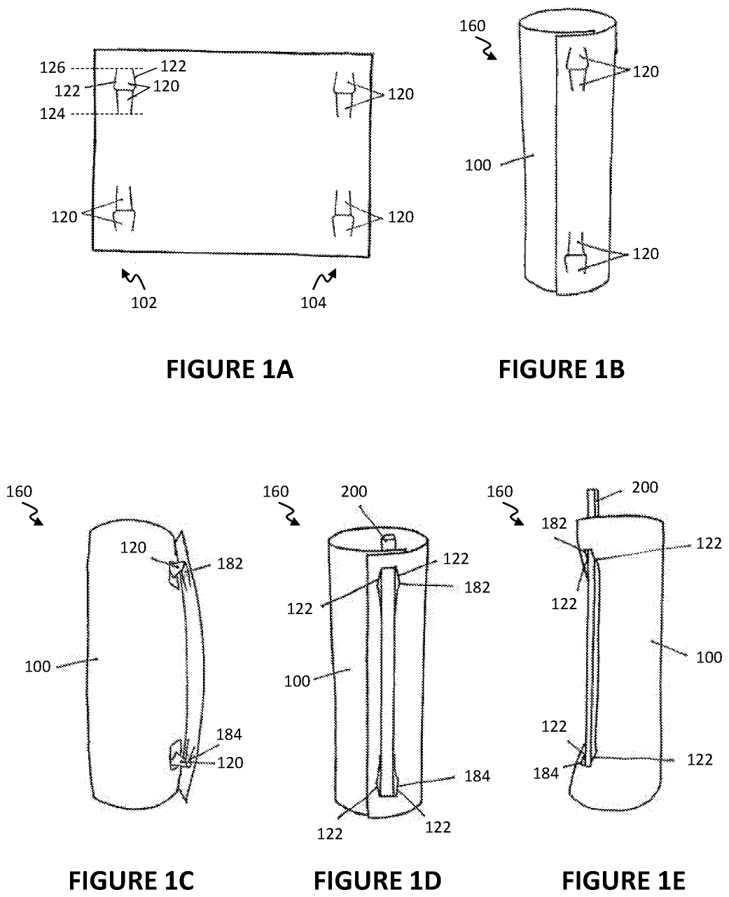

FIG. 1A illustrates a sheet 100 that can be configured to define an enclosure of a guard. The guard is for protecting a plant or tree from windy conditions and/or from predation.

The sheet 100 is a cardboard blank. The sheet 100 is made from a flexible material that can be rolled to define the enclosure. In another example, the sheet may be made from a rigid material that can be folded to define the enclosure. In this other example, the sheet may be provided with one or more fold lines about which the sheet may be folded to define the enclosure. The sheet may be comprised of one or several substrates having different weights or thicknesses. For example, the sheet is a solid wall or is twin-walled. The sheet may be made from plastic such as a polyethylene plastic or polypropylene plastic, from fiber such as cardboard or paper pulp, from a plant fiber such as bagasse, from a recyclable material and/or from a biodegradable material. The sheet typically has a thickness of up to about 4 mm depending on the size or dimensions of the enclosure required and on the material used. The sheet has a width, corresponding to a height of the enclosure. By way of example the width of the sheet may be up to about 50 cm, preferably between about 40 cm and 45 cm. By way of another example, the width of the sheet may be up to about 1 m or up to about 2 m. The sheet can be scaled up or down depending on the application and on the dimensions of stake(s) that are used to secure it.

The sheet 100 has tab portions 120 located at or near the corners of the sheet. As will be described in further detail below, these tab portions are foldable to retain the configuration of the enclosure and to provide apertures through which a stake can be passed for securing the enclosure to a ground surface. Particularly, at or near each corner of the sheet, there is provided two tab portions 120 that are foldable away from each other. A first region 102 of the sheet has two sets of tab portions located at or near corners of the sheet in that region, while a second region 104 of the sheet has two other sets of tab portions located at or near corners of the sheet in that region. The first region and the second region are located at opposite sides of the sheet. Folding one or both of the tab portions 120 reveals an aperture through the sheet at or near the respective corner of the sheet. The tab portions are formed by making cuts in areas at or near the corners of the sheet, thereby reducing any wastage of sheet material. The shape of the aperture therefore corresponds to the shape of the tab portions. This aperture is at least thumb size. That is, a user can fit their thumb through the aperture. In use, the user can fold one of the tab portions by pushing against the tab portion into the sheet using their thumb. The aperture has an aperture height (or aperture length) that is preferably greater than the aperture width. The aperture height may be greater than 1.2 times the aperture width, and preferably greater than 2 times the aperture width. The aperture width is greater than about 1 cm and may be up to about 4 cm.

In other embodiments, the tab portions may be provided in the first region towards one side of the sheet with holes being provided in the second region towards the other side of the sheet. In these embodiments, the tab portions in the first region are foldable into the holes in the second region and over the hole.

In yet other embodiments, the tab portions may be located at diagonally opposite corners of the sheet with holes into which the tab portion can be folded being located in corresponding diagonally opposite corners of the sheet. In these embodiments, the first region has a tab portion at or near an upper corner of the sheet and a hole at or near a lower corner of the sheet, while the second region has a hole at or near an upper corner and a tab portion at or near a lower corner of the sheet.

Each aperture is defined by two side edges 122. The side edges 122 of an aperture preferably have portions that are nonparallel to each other. That is, portions of one side edge of an aperture are nonparallel to portions of the other side edge of the aperture. The side edges of the aperture includes portions that are angled away from each other, curved, and angled towards each other.

Each aperture is further defined at least by an upper edge and a lower edge that are vertically spaced apart from each other to define a space therebetween in which the elongate support is received. The upper and lower edges define fold axes 124, 126 about which the tab portions 120 are foldable. The two side edges 122 extend between these two vertically spaced apart edges. A first one of these vertical edges has a width that is substantially equal to or less than a width of an elongate support that is located through the aperture. The two side edges extend away from each other to provide the aperture with an opening through which the elongate support can pass. The opening has a width that is greater than the width of the elongate support. Each side edge extends from the first edge by an angle of greater than 90°, for example between about 91° and 120°, and preferably about 100°.

As mentioned previously, the first region 102 of the sheet has two sets of tab portions 120 located at or near corners of the sheet in that region, while the second region 104 of the sheet has two other sets of tab portions 120 located at or near corners of the sheet in that region. The first and second regions are located towards opposite sides of the sheet. Referring to FIG. 1B, to erect the enclosure 160, the sheet 100 is rolled such that the tab portions 120 in the first region 102 are generally aligned with the tab portions 120 in the second region 104. Rolling the sheet 100 defines a cylindrical enclosure 160 with a substantially circular cross section. The plant or tree to be protected is located within the enclosure 160. In other embodiments, the enclosure may have a height with a substantially triangular-shaped cross-sectional area, with a substantially rectangular-shaped cross-sectional area, or other geometric or non-geometric cross-sectional profile. The tab portions 120 act as locking tabs for locking the configuration of the enclosure 160. When the enclosure is no longer required, the tab portions can be unfolded and the enclosure can be unrolled (or unfolded) into a sheet 100.

The sheet 100 defines a wall arrangement of the enclosure 160. The wall arrangement is a continuous wall that surrounds the plant or tree to be protected. In other embodiments, the wall arrangement may include more than one wall. For example, the wall arrangement can have two walls defining a semi-cylindrical enclosure; three walls defining an enclosure with a triangular profile; four walls defining a square, rectangular, parallelogram, or trapezoidal profile; or more than four walls. Where the wall arrangement has more than one wall, the sheet may have fold lines or crease lines to assist with folding the sheet to provide the walls of the enclosure.

The wall arrangement defines a solid barrier into the enclosure. The wall arrangement protects the plant or tree in the enclosure from windy conditions and predation.

Referring to FIG. 1C, once the tab portions 120 are generally aligned, the user pushes at least one of the tab portions 120 at each corner of the sheet and folds them into the enclosure to thereby retain the configuration of the enclosure. The tab portions 120 are folded in an upward direction or a downward direction relative to the enclosure on the ground surface. Having the apertures thumb-sized make it easier for the user to align while the user folds the tab portions 120 into the enclosure 160.

Folding the tab portions 120 into the enclosure reveals the two apertures 182, 184 vertically spaced apart from each other. In other embodiments, the wall arrangement may have more than two apertures spaced apart from each other through which the elongate support is passable. For example, the wall arrangement may have three apertures, four apertures, five apertures, or more than five apertures that are generally in line with each other through which the elongate support is passable.

Referring to FIGS. 1D and 1E, an elongate support 200 skewers the enclosure 160 through the two apertures 182, 184 in the sheet 100 to secure the enclosure to the ground surface. The elongate support 200 is a wooden stake with a substantially square cross-sectional area. The elongate support 200 has, along a substantial length of the elongate support 200 a cross-sectional area with a width of between about 10 mm and 30 mm and a depth of between about 10 mm and 30 mm. As an example, the elongate support has a width of about 25 mm and a depth of about 15 mm.

The elongate support 200 passes through one aperture 182 from a first side of the enclosure 160, exits that aperture 182 and enters the other aperture 184 from a second side of the enclosure, and exits that other aperture 184 from the first side of the enclosure. The first side of the enclosure corresponds to an inside surface of the enclosure and the second side of the enclosure corresponds to an outside surface of the enclosure. In other arrangements, the first side corresponds to an outside surface of the enclosure and the second side corresponds to an inside surface of the enclosure.

In skewering the wall of the enclosure 160 with the elongate support 200 through the two apertures 182, 184, the portion of the elongate support 200 between the two apertures 182, 184 pushes against the wall in a first direction, while portions of the elongate support not-between the two apertures (i.e. a portion of the elongate support above the upper aperture and a portion of the elongate support below the lower aperture) push against the wall in a second direction opposite to the first direction. Thereby, the elongate support 200 forces the first and second regions 102, 104 of the wall arrangement against each other to retain the configuration of the enclosure 100. When the elongate support skewers the apertures, the upper and lower edges of the aperture are spaced apart from each other by a distance corresponding to a depth of the elongate support.

Portions of the side edges 122 of the aperture have a clamping effect on sides of the elongate support 200, along a length portion, when the elongate support 200 is received by the aperture. For example, the clamping effect includes the portions of the side edges 122 hugging, embracing, or frictionally contacting the sides of the elongate support 200. The clamping effect of the side edges 122 on the elongate support 200 is spread along a length portion and across a depth portion of the elongate support on opposite sides of the elongate support, which minimizes the rotation of the enclosure relative to the elongate support.

The apertures, with their angled narrowing or converging sides 122, minimizes the guard from swiveling on the elongate support in heavy winds and also makes it easy for the elongate support to be guided through the aperture. Additionally, having the angled sides 122 allows for the enclosure to accommodate elongate supports of varying sizes while providing the clamping effect on the sides of the elongate support to reduce rotational movement of the enclosure relative to the elongate support.

The folded tab portions 120 of the sheet frictionally contact a surface of the elongate support received by the aperture. The frictional contact of the elongate support by the tab portions further reduces the swiveling or rotational movement of the enclosure relative to the elongate support. The folded tab portions 120 also provide extra stiffness or rigidity to the wall arrangement, in a vicinity of the aperture, against which the elongate post through the aperture presses. In particular, the tab portions, when folded, result in a multi layered wad or in an area of increased stiffness/rigidity. The folded tab portion creates a pressure point on the surface of the elongate support; as the elongate support is inserted through the enclosure, the elongate support pushes a top section of enclosure and angles it outwards towards a horizontal position. This angle enhances the clamping effect provided by the side edges of the aperture on the sides of the elongate support. The angled edges of the aperture run down a length and across a side/width of the elongate support to trap the elongate support therebetween.

The tab portions 120 further allow for the sheet 100 to be configured into an enclosure and retained in that configuration without any welding, glue or stapling.

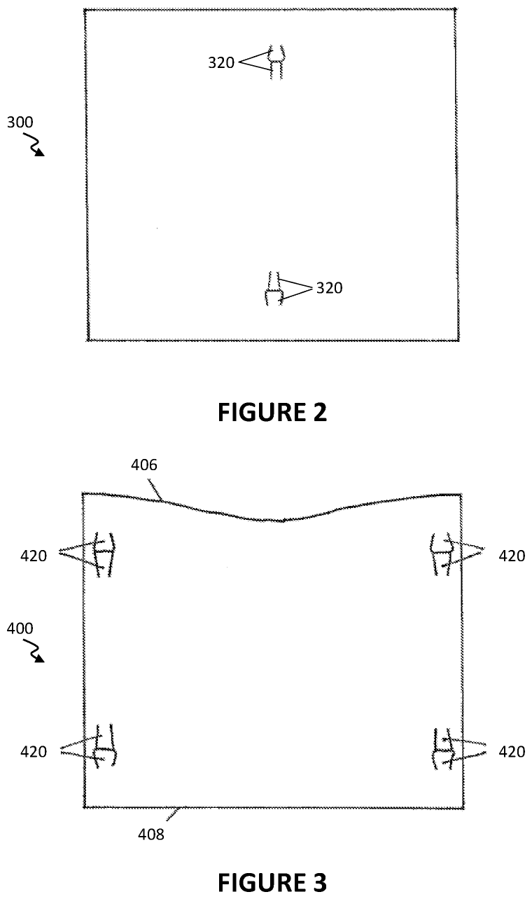

Referring to FIG. 2, a sheet 300 for a guard according to another embodiment of the present invention is disclosed. Unless otherwise described, features of the guard 300 are similar to features of the guard described with reference to FIGS. 1A to 1E indicated by reference numerals with the addition of 200. The sheet 300 has tab portions 320 located centrally of the sheet 300 for receiving an elongate support for securing the sheet to a ground surface. The sheet 300 is rolled or folded to form the guard. In order to retain the guard configuration of the sheet, the sheet could have tab portions (not shown) along the opposite edge of the sheet such that the edges of the sheet meet each other when the guard is formed and the tab portions engage each other to lock the configuration of the guard. Alternatively, edges of the sheet when brought together to form the guard can be fastened, welded, stitched or glued together to retain the guard configuration. In other embodiments, the sheet may have smaller tab portions near the corners of the sheet for receiving a thinner elongate support (such as a bamboo stick for example) for securing the guard to the ground surface, in addition to the elongate support through the tab portions securing the guard to the ground surface.

Referring to FIG. 3, another sheet 400 for a guard according to another embodiment of the present invention is disclosed. Unless otherwise described, features of the guard 400 are similar to features of the guard described with reference to FIGS. 1A to 1E indicated by reference numerals with the addition of 300. The sheet 400 has tab portions 420 located near the corners of the sheet 400 for receiving an elongate support. The sheet has a first edge 406 that is concaved or curved and a second edge 408 that is straight. When the sheet 400 is rolled to form an enclosure, the first or second edges can be used as the base of the enclosure depending on the slope of the ground surface on which the enclosure is located. In particular, the concave first edge 406 provides the enclosure with a sloping or angled base while the flat second edge 408 provides the enclosure with a flat base. If the enclosure is to be located on a ground surface with a slope, the concave first edge 406 can be used as a base of the enclosure thereby keeping the wall(s) of the enclosure substantially upright when the enclosure is located on the sloping surface. On the other hand, if the enclosure is to be located on a substantially flat ground surface, the flat second edge 408 can be used as the base of the enclosure thereby keeping the walls of the wall(s) of the enclosure substantially upright when the enclosure is located on the surface.

In other embodiments of the present invention, two or more of the sheets described above can be used to provide a larger enclosure. In these other embodiments, the first region of a first sheet is aligned with a first region of a second sheet while the second region of the first sheet is aligned with a second region of the second/another sheet. A first elongate support is used to skewer the enclosure through the apertures in the first regions of the first and second sheets, while a second elongate support is used to skewer the enclosure through the apertures in the second regions of the first and second/another sheets.

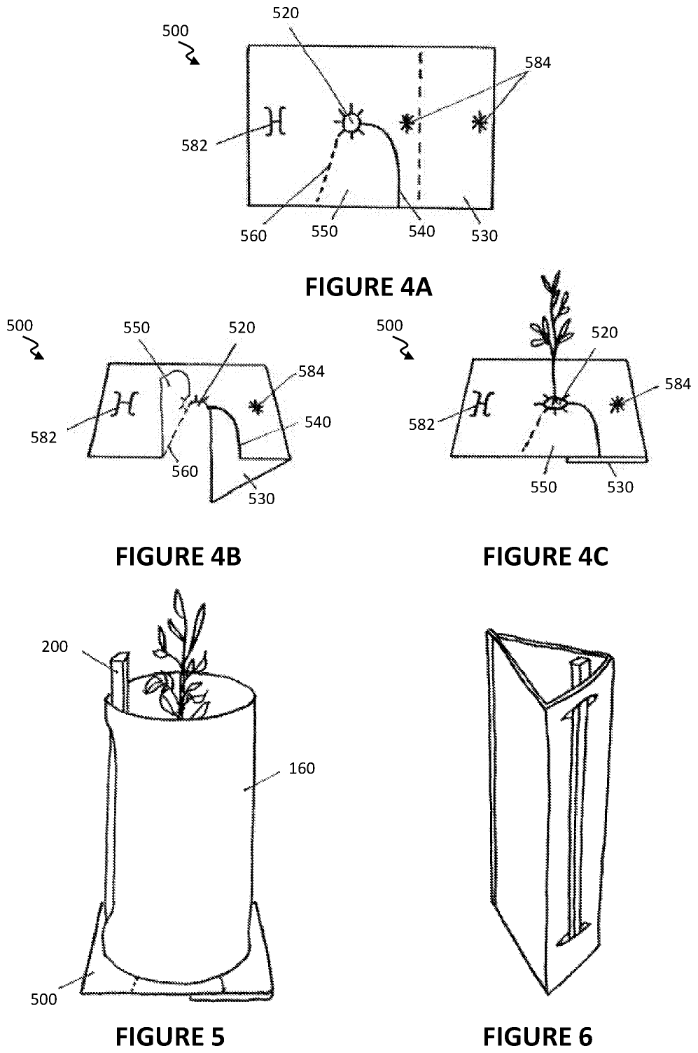

Referring to FIGS. 4A to 4C, a mat 500 is disclosed to manage weed growth and moisture loss around the base of the plant. Weed growth is one of the biggest killers or growth inhibitors for plants. Weeds draw nutrients and moisture out of the soil and out compete young seedlings.

The mat 500 has an aperture 520 in which a plant to be protected can be located. The mat 500 has a curved slot 540 from an edge of the mat 500 to the aperture 520 to define a flap portion 550 that can be folded away from the rest of the mat to define a passage or an entry for the plant into the aperture. The mat has a fold line (or crease line) 560 about which the flap portion 550 is foldable. A portion 530 of the mat is foldable such that the mat portion 530 can be folded to cover the curved slot 540 to thereby prevent any moisture or growth through the slot 540. Once the plant is located in the aperture, the mat portion 530 is folded such that it is underneath the rest of the mat and covers the curved slot 540. When the mat portion 530 is folded a region of the mat portion would be visible in the passage leading to the aperture. The flap portion 550 can then be folded back thereby covering the region of the mat portion 530 and the ground surface surrounding the plant to block light to and prevent weed growth around the base of the plant. The curve of the slot 540 prevents the edges from curling and prevents leading edge of the flap from lifting thereby causing the mat to lose its substantially flat profile.

The mat 500 has guide holes 582, 584 for receiving an elongate support, including a stake and bamboo stakes, for securing the guard to the ground surface.

For example, once the mat 500 is in place on a ground surface to surround the plant, one or more elongate supports can be driven through the holes of the mat 500. The enclosure previously described above can then be inserted onto the mat with the elongate support skewering the enclosure. The enclosure is pushed down onto the mat to firmly hold the mat in place.

Alternatively, the elongate support can be passed through the enclosure first before the elongate support is inserted through the guide hole in the mat.

FIG. 5 shows the guard 160 described with reference to FIGS. 1A to 1D on the mat 500 described with reference to FIGS. 4A to 4C.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A guard including:
a wall arrangement defining, or being configurable to define, an enclosure, the wall arrangement having, or being configurable to have, an aperture for receiving an elongate support to secure the enclosure to a ground surface, the aperture being defined at least by two side edges that provide the aperture with an aperture height and that are spaced apart from each other to provide the aperture with an aperture width.

2. The guard of claim 1, wherein the aperture height is greater than the aperture width.

3. The guard of claim 1, wherein the side edges contact the elongate support, when received by the aperture, along a length of the elongate support.

4. The guard of claim 1, wherein the side edges of the aperture frictionally contact a length portion of the elongate support when the elongate support is received by the aperture.

5. The guard of claim 1, wherein the side edges have portions that are nonparallel to each other.

6. The guard of claim 1, wherein the aperture has a first edge from which the two side edges extend, the first edge having a width that is substantially equal to or less than a width of the elongate support and the two side edges extend away from each other to provide the aperture with an opening through which the elongate support can pass, the opening having a width that is greater than the width of the elongate support, wherein the aperture has a space between the side edges that gradually increases from the first edge that is towards the opening.

7. The guard of claim 1, wherein the wall arrangement is made from plastic, natural fiber, cardboard, plant fiber, recyclable material and/or biodegradable material.

8. The guard of claim 1, wherein the wall arrangement defines a solid barrier into the enclosure.

9. The guard of claim 1, wherein the wall arrangement has, or is configurable to have, two apertures vertically spaced apart from each other, the wall arrangement being skewerable through the two apertures to secure the enclosure to the ground surface.

10. The guard of claim 9, wherein a portion of the elongate support between the two apertures pushes against the wall arrangement in a first direction, and portions of the elongate support not-between the two apertures push against the wall arrangement in a second direction opposite to the first direction.

11. The guard of claim 1, wherein the wall arrangement has a first region with a tab portion and a second region, wherein the tab portion in the first region is foldable towards the second region to substantially retain the configuration of the enclosure such that, when the tab is folded, the aperture is provided through which the elongate support is passable to secure the enclosure to a ground surface.

12. A guard including:
a wall arrangement being configurable to define an enclosure, the wall arrangement having a first region with a tab portion and a second region, wherein the tab portion in the first region is foldable towards the second region to substantially retain the configuration of the enclosure such that, folding the tab reveals an aperture through which an elongate support is passable to secure the enclosure to a ground surface.

13. The guard of claim 11, wherein the first region is provided towards one end of the sheet and the second region may be provided towards an opposite end of the sheet.

14. The guard of claim 10, wherein the second region of the wall arrangement has a tab portion that is foldable such that the tabs portions in the first and second regions, when aligned, are foldable towards the second region or towards the first region to provide the aperture through which the elongate support is passable.

15. The guard of claim 10, wherein the tab portion(s), when folded to provide the aperture, frictionally contact a surface of the elongate support when the aperture receives the elongate support.

16. The guard of claim 10, wherein the enclosure has an angled end that can be used as a base of the enclosure such that when the angled end is used as the base on a sloping ground surface, the wall arrangement is substantially upright.

17. A guard including:
a wall arrangement defining, or being configurable to define, an enclosure, the enclosure having an angled end that can be used as a base of the enclosure such that when the angled end is used as the base on a sloping ground surface, the wall arrangement is substantially upright.

18. The guard of claim 17, wherein the enclosure has an opposite end that is substantially flat that can be used as the enclosure base, such that when the opposite end of the enclosure is used as the base on a substantially flat ground surface, the wall arrangement is substantially upright.

19. A sheet for forming the guard of claim 1.

20. A mat including a sheet having an aperture for receiving a plant, the sheet having a slot extending from an edge of the sheet toward the aperture to define a flap that is foldable to provide a passage into the aperture.

21. The mat of claim 20, wherein the slot has a curved portion.
